(19) United States
(12) Patent Application Publication
(10) Pub. No.: US 2017/0258044 A1
(43) Pub. Date: Sep. 14, 2017

(54) ANIMAL TOY

(71) Applicant: Doskocil Manufacturing Company, Inc., Arlington, TX (US)

(72) Inventors: Ryan WILLS, Carrollton, TX (US); Norman ANDERSON, Brooklyn, NY (US)

(21) Appl. No.: 15/067,529

(22) Filed: Mar. 11, 2016

(51) Int. Cl. A01K 15/02

(52) U.S. Cl. CPC A01K 15/025

(57) ABSTRACT

An articulated animal toy that includes at least a first body portion, a mid-body portion and a second body portion each having an outer surface an animal head, an animal body and an animal tail. Adjacent pairs of the first body portion, the mid-body portion and the second body portion define a socket connection end and a swivel connection end. The swivel connection ends are snap-fitted into the adjacent socket connection end defining swivel joints. The swivel joints are freely pivotal about respective axes such that the first body portion is pivotally connected to the mid-body portion and the mid-body portion is pivotally connected to the second body portion. In response to the first body portion, the mid-body portion and the second body portion being pulled along a floor surface, the first body portion, the mid-body portion and the second body portion freely pivot relative to one another.

### BACKGROUND

Field of the Invention

The present invention generally relates to an animal toy. More specifically, the present invention relates to an animal toy with articulated joints between body sections such that when pulled along a floor surface, the body sections freely pivot relative to one another.

Background Information

Pets enjoy toys. In particular, cats enjoy chasing toys that are pulled along the floor attracting their attention.

### SUMMARY

On object of the disclosure, is to provide an animal toy with articulated joints such that when pulled along a floor surface, various body section of the toy are free to wiggle and/or pivot relative to one another, attracting an animal's attention.

In view of the state of the known technology, one aspect of the present disclosure is to provide an articulated animal toy with a first body portion, at least one mid-body portion and a second body portion. The first body portion has an outer surface that defines one of an animal tail and an animal head, and has a first socket connection end. The at least one mid-body portion has an outer surface that defines at least a portion of an animal body, a first swivel connection end and a second socket connection end. The second body portion has an outer surface that defines the other of the animal tail and the animal head, and has a second swivel connection end. The first swivel connection end is snap-fitted into the first socket connection end defines a first swivel joint. The second swivel connection end is snap-fitted into the second socket connection end defines a second swivel joint. The first swivel joint is pivotal about a first axis and the second swivel joint is freely pivotal about a second axis such that the first body portion is pivotally connected to the at least one mid-body portion and at least one the mid-body portion is pivotally connected to the second body portion. In response to the first body portion, the at least one mid-body portion and the second body portion being pulled along a floor surface, the first body portion, the at least one mid-body portion and the second body portion freely pivot relative to one another.

### BRIEF DESCRIPTION OF THE DRAWINGS

Referring now to the attached drawings which form a part of this original disclosure:

FIG. 1 is a side view of an animal toy having a plurality of body portions connected to one another by loose articulated joints in accordance with a first embodiment;

FIG. 2 is another side view of the animal toy depicted in FIG. 1 showing the body portions moved relative to a vertical plane via the articulated joints arcing upward in accordance with the first embodiment;

FIG. 3 is yet another side view of the animal toy depicted in FIGS. 1 and 2 showing the body portions moved relative to the vertical plane arcing downward via the articulated joints in accordance with the first embodiment;

FIG. 4 is top view of the animal toy depicted in FIGS. 1-3 in accordance with the first embodiment;

FIG. 5 is another top view of the animal toy depicted in FIGS. 1-4 showing the body portions moved relative to a horizontal plane via the articulated joints arcing in a first direction in accordance with the first embodiment;

FIG. 6 is yet another top view of the animal toy depicted in FIGS. 1-5 showing the body portions moved relative to the horizontal plane via the articulated joints arcing in a second direction in accordance with the first embodiment;

FIG. 7 is an exploded perspective view of the animal toy depicted in FIGS. 1-6 showing the various body portions separated from one another revealing swivel connection ends and socket connection end that snap-fitted together forming the animal toy and the articulated joints in accordance with the first embodiment;

FIG. 8 is a side view of a head portion of the animal toy depicted in FIGS. 1-7 showing the swivel connection end thereof in accordance with the first embodiment;

FIG. 9 is a side and partial cross-sectional view of a mid-body portion of the animal toy depicted in FIGS. 1-7 showing the socket connection end and the swivel connection end thereof in accordance with the first embodiment;

FIG. 10 is a side and partial cross-sectional view of a tail portion of the animal toy depicted in FIGS. 1-7 showing the socket connection end thereof in accordance with the first embodiment;

FIG. 11 is a top and partial cross-sectional view of the animal toy depicted in FIGS. 1-7, showing the head portion, the mid-body portion and the tail portion attached to one another via the articulated joints defined by the snap-fitting attachments between the various socket connection ends and swivel connection ends thereof in accordance with the first embodiment;

FIG. 12 is a side view of an animal toy having a plurality of body portions connected to one another by loose articulated joints in accordance with a second embodiment;

FIG. 13 is a perspective view of an animal toy in accordance with a third embodiment;

FIG. 14 is a first perspective exploded view of the animal toy in accordance with the third embodiment;

FIG. 15 is a second perspective exploded view of the animal toy in accordance with the third embodiment;

FIG. 16 is a partial cross-sectional side view of a portion of the animal toy in accordance with the third embodiment;

FIG. 17 is another partial cross-sectional side view of a portion of the animal toy in accordance with the third embodiment;

FIG. 18 is a perspective view of an animal toy having a first body portion, a plurality of mid-body portions and a seconds body portion in accordance with a fourth embodiment;

FIG. 19 is a side view of the animal toy depicted in FIG. 18 in accordance with the fourth embodiment;

FIG. 20 is a partial cross-sectional side view of one of the plurality of mid-body portions of the animal toy in accordance with the fourth embodiment;

FIG. 21 is a perspective view of the first body portion of the animal toy showing upper surface details in accordance with the fourth embodiment;

FIG. 22 is a perspective view of the first body portion of the animal toy showing lower surface details in accordance with the fourth embodiment;

FIG. 23 is a perspective view of one of the plurality of mid-body portions of the animal toy showing lower surface in accordance with the fourth embodiment;

FIG. 24 is a perspective view of details the second body portion of the animal toy showing lower surface details in accordance with the fourth embodiment;

FIG. 25 is a perspective view of an animal toy having a first body portion, a plurality of mid-body portions and a seconds body portion in accordance with a fifth embodiment;

FIG. 26 is a side view of the animal toy depicted in FIG. 25 in accordance with the fifth embodiment;

FIG. 27 is another side view of the animal toy depicted in FIGS. 25 and 26, showing relative movement between the various body portions in accordance with the fifth embodiment;

FIG. 28 is a top view of the animal toy in accordance with the fifth embodiment;

FIG. 29 is a bottom view of the animal toy in accordance with the fifth embodiment;

FIG. 30 is a partial cross-sectional side view of one of the plurality of mid-body portions of the animal toy in accordance with the fifth embodiment;

FIG. 31 is a partial cross-sectional top view of one of the plurality of mid-body portions of the animal toy in accordance with the fifth embodiment;

FIG. 32 is a perspective view of the first body portion of the animal toy showing upper surface details in accordance with the fifth embodiment; and

FIG. 33 is a perspective view of one of the plurality of mid-body portions of the animal toy showing lower surface in accordance with the fourth embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

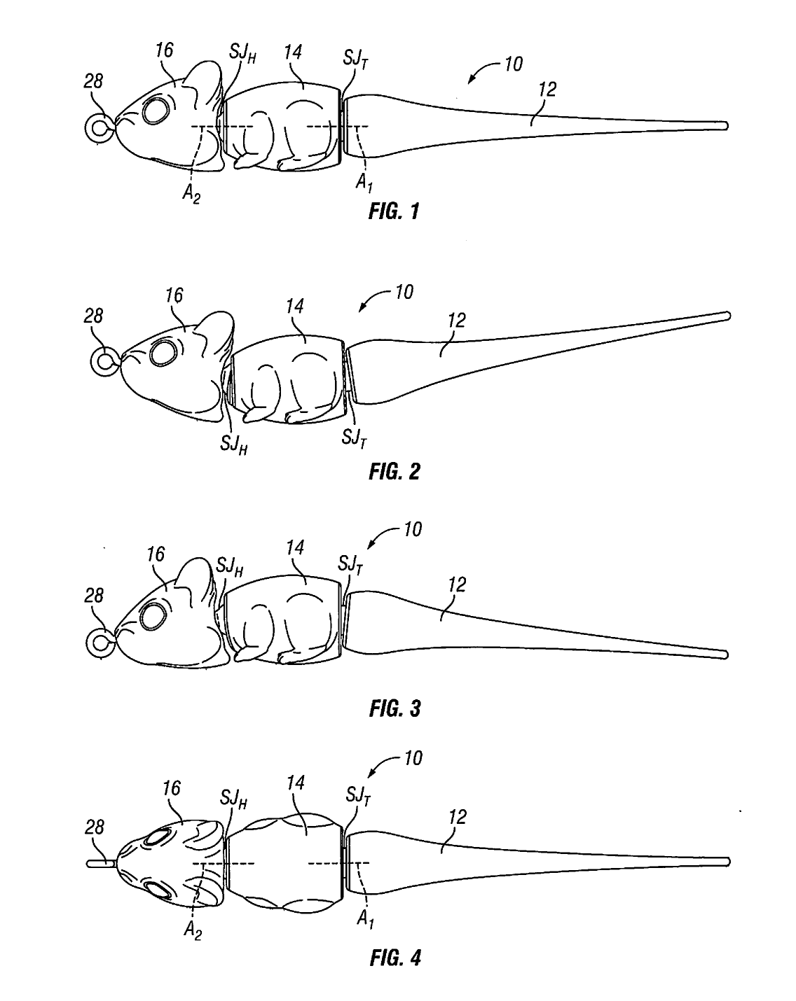

Referring initially to FIGS. 1-11, an animal toy 10 is illustrated in accordance with a first embodiment. The animal toy 10 is shaped and configured to have the appearance of a mouse with a long tail having articulating joints.

The animal toy 10 in the first embodiment basically includes three elements, a first body portion 12, a mid-body portion 14 and a second body portion 16. The first body portion 12 defines an end portion of an animal. In the first embodiment, a rear end of the first body portion 12 has the appearance of a mouse tail. A forward end of the first body portion 12 has a first socket connection end 20, shown in FIGS. 7, 10 and 11.

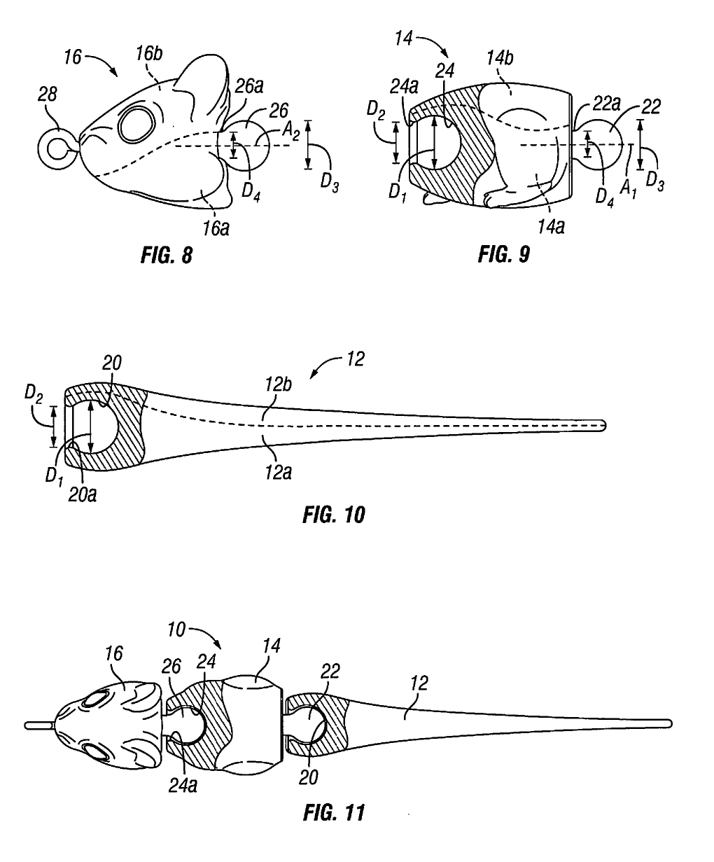

The mid-body portion 14 has an outer surface that defines or has the appearance of an animal body, specifically, a mouse body. The mid-body portion 14 has a first swivel connection end 22 and a second socket connection end 24 opposite the first swivel end 22, as shown in FIGS. 8, 9 and 11.

The second body portion 16 has an outer surface with a front end that defines an animal head, specifically, a mouse head. The second body portion 16 also has a second end that has a second swivel connection end 26, as shown in FIGS. 7 and 8. The front end of the second body portion 16 also includes a hook or loop 28 such that a string can be attached to the animal toy 10. With the string (not shown) attached to the loop 28, the animal toy 10 can be pulled along a floor surface (not shown) to attract the attention of a pet.

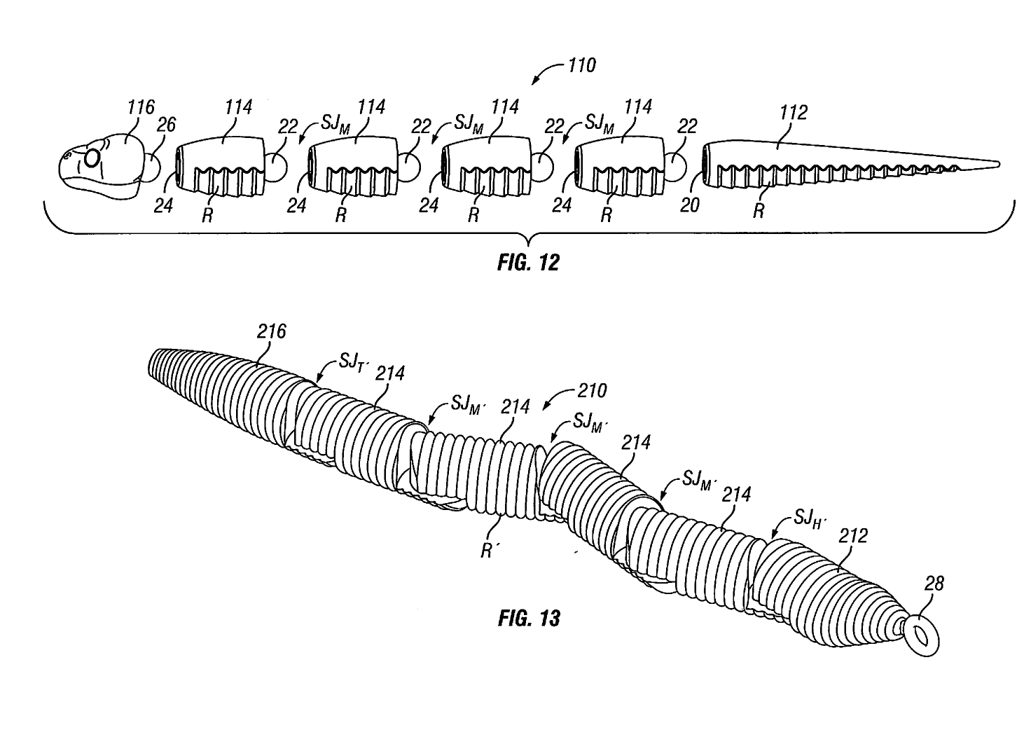

The animal toy 10 is assembled as follows. The first swivel connection end 22 of the 22 of the mid-body portion 14 is snap-fitted into the first socket connection end 20 of the first body portion 12 defining a first swivel joint SJ_{T} (swivel joint at the tail of the animal toy 10), as shown in FIG. 11. The second swivel connection end 26 of the second body portion 16 is snap-fitted into the second socket connection end 24 of the mid-body portion 14 defining a second swivel joint SJ_{H} (swivel joint at the heat of the animal toy 10), as also shown in FIG. 11.

The first swivel joint SJ_{T} is pivotal about a first axis A₁ and the second swivel joint SJ_{H} is freely pivotal about a second axis A₂ such that the first body portion 12 is pivotally connected to the mid-body portion 14 and the mid-body portion 14 is pivotally connected to the second body portion 16. In response to the first body portion 12, the mid-body portion 14 and the second body portion 16 being pulled along a floor surface (not shown), the first body portion 12, the mid-body portion 14 and the second body portion 16 freely pivot relative to one another.

For purposes of understanding the invention, the first axis A₁ is defined herein relative to the first swivel connection end 22 of the mid-body portion 14. However, it should be understood from the drawings and the description that the first axis A₁ could alternatively be defined as being relative to the first socket end 20 of the first body portion 12. Similarly, for purposes of understanding the invention, the second axis A₂ is defined herein relative to the second swivel connection end 26 of the second body portion 16. However, it should be understood from the drawings and the description that the second axis A₂ could also be defined as being relative to the second socket connection end 24 of the mid-body portion 14.

As shown in FIG. 10, the first socket connection end 20 has basically a spherical shape with an opening 20a. The first socket connection end 20 has an inner diameter of D₁. The opening 20a has a diameter D₂ that is smaller than the diameter D₁.

As shown in FIG. 9, the first swivel connection end 22 of the mid-body portion 14 also basically has a spherical shape with a neck portion 22a. The spherical shape of the first swivel connection end 22 has a diameter D₃ and the neck portion 22a has a diameter D₄ that is smaller than the diameter D₃.

The second socket connection end 24 of the mid-body portion 14 further has a spherical shape and an opening 24a. Like the first socket connection end 20, the second socket connection end 24 has an inner diameter that is equal to the diameter D₁. Similarly, the opening 24a has a diameter that is equal to the diameter D₁ of opening 20a of the first socket connection end 20.

The second swivel connection end 26 is basically the same as the first swivel connection end 22. Specifically, the second swivel connection end 26 has a spherical shape with a neck portion 26a. The second swivel connection end 26 has an outer diameter that is equal to the diameter of D₃. The neck portion 26a has an outer diameter that is equal to the diameter D₄.

As mentioned above, first swivel joint SJ_{T} is defined by the snap-fitting connection that includes the first swivel connection end 22 being snap-fitted into the first socket connection end 22. Similarly, second swivel joint SJ_{H} is defined by the snap-fitting connection that includes the second swivel connection end 26 being snap-fitted into the second socket connection end 24. Since the first and second swivel connection ends 24 and 26 have identical dimensions (diameters D₃ and D₄) and the first and second socket connection ends 20 and 22 have identical dimensions (diameters D₁ and D₂), the first swivel joint SJ_{T} and the second swivel joint SJ_{H} are basically identical and respond to outside forces in similar, if not identical manners.

The diameter D₁ of the first and second socket connection ends 20 and 22 is larger than the diameter D₃ of each of the first and second swivel connection ends 24 and 26. Further the difference between the diameter D₁ and the diameter D₃ is such that the first swivel joint SJ_{T} and the second swivel joint SJ_{H} are loose joints allowing free pivoting and swiveling movement between the first body portion 12, the mid-body portion 14 and the second body portion 16. In other words, the diameter D₁ and the diameter D₃ are dimensioned such that there is little if any friction generated by movement between the first swivel connection end 22 and the first socket connection end 20, and little if any friction generated by movement between the second swivel connection end 26 and the second socket connection end 24. Further, the animal toy 10 is preferably molded from a material that reduces or prevents the possibility of friction being generated within the first swivel joint SJ_{T} and the second swivel joint SJ_{H}. Further, the body portions of the animal toy 10 are molded of a resilient material that can undergo sufficient elastic deformation to allow snap-fitting assembly of the various body portions.

Further, the diameter D₄ of each of the neck portion 22a and the neck portion 26a is smaller than the diameter D₂ of each of the opening 20a and the opening 24a. Specifically, the diameter D₄ is 20-40 percent smaller than the diameter D₂. Therefore, once the first swivel connection end 22 is snap-fitted into the first socket connection end 20 and the second swivel connection end 26 is snap-fitted into the second socket connection end 24, openings 20a and 24a allow for a large amount of freedom of movement of the neck portions 22a and 26a.

Hence, the first swivel joint SJ_{T} allows free pivotal, swiveling and rotational movements between the first body portion 12 and the mid-body portion 14 about the first axis A₁. Similarly, the second swivel joint SJ_{H} allows free pivotal, swiveling and rotational movements between the second body portion 16 and the mid-body portion 14 about the second axis A₂. As used herein, the pivotal movement referred to herein refers to any pivot-like movements of one body portion of the animal toy 10 about the axis defined by the swivel connection end the body portion is snap-fitted to, including pivoting movement along any given plane, vertical, horizontal or otherwise. The swiveling movement referred to herein refers to any movements of one body portion of the animal toy 10 relative to the axis defined by the swivel connection end the body portion is snap-fitted to, including three dimensional movements observed from several orthogonal views simultaneously. The rotational movement about one of the axis A₁ and A₂, refers to actual rotation of one body portion about the axis defined by the swivel connection end the body portion is snap-fitted to.

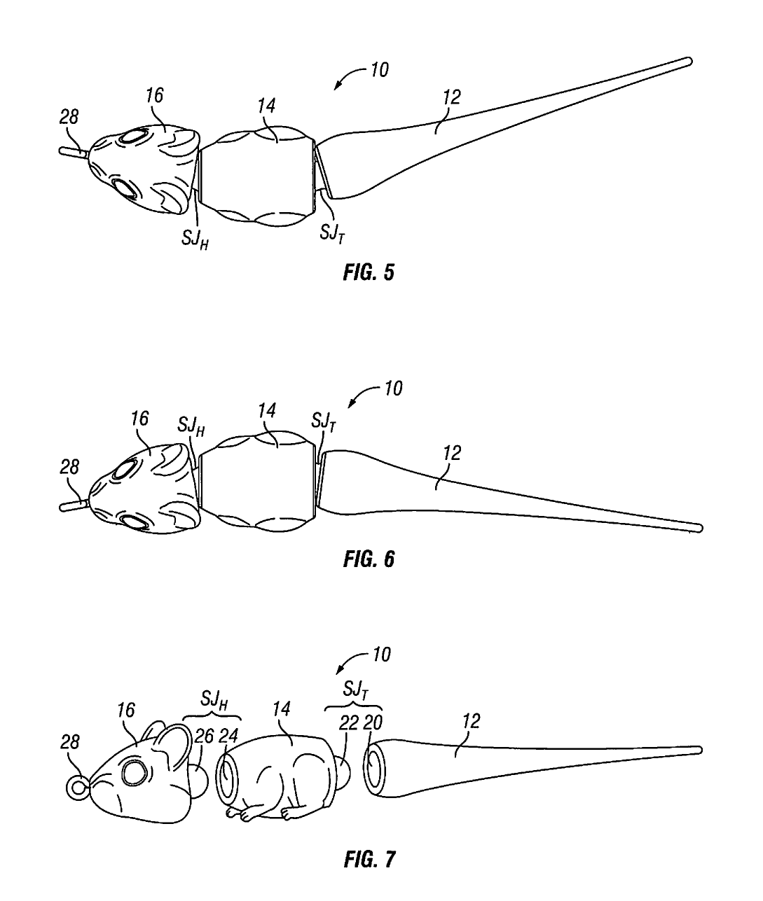

Specifically, when the animal toy 10 is pulled along the floor surface, the mid-body portion 14 can appear to wiggle relative to the second body portion 16, and the first body portion 12 can appear to wiggle relative to the mid-body portion 14. For example as shown in FIGS. 2 and 3 viewed from one side of the animal toy 10, if the floor surface is uneven (not level), the first body portion 12 (the tail portion) can move up and down relative a vertical plane relative to the mid-body portion 14 and the mid-body portion 14 can move up and down relative the vertical plane relative to the second body portion 16 (the head portion), where the vertical plane corresponds to a plane defined by the view in FIGS. 2 and 3. Similarly, as shown in FIGS. 5 and 6 viewed from above, the first body portion 12 (the tail portion) can move right and left down relative a horizontal plane relative to the mid-body portion 14 and the mid-body portion 14 can move left and right relative the horizontal plane relative to the second body portion 16 (the head portion), where the horizontal plane corresponds to a plane defined by the view in FIGS. 5 and 6.

However, it should be understood from the drawings and description herein, that the first body portion 12 rotates, pivots and/or swivels about the first axis A₁, and the mid-body portion 14 rotates, pivots and/swivels about the second axis A₂ as the animal toy 10 is pulled along the floor surface. Since, the animal toy 10 can undergo articulated movement due to the design of the first swivel joint SJ_{T} and the second swivel joint SJ_{H}, the animal toy 10 is an articulating animal toy with a wide range of movement between the first body portion 12, the mid-body portion 14 and the second body portion 16, as the animal toy 10 is pulled along a floor surface of any surface in order to attract the attention of a pet and entertain the pet.

In the first embodiment, the first axis A₁ and the second axis A₂ of the animal toy 10 are horizontally oriented with the animal toy 10 positioned along the floor surface in a horizontal orientation. The first axis A₁ and the second axis A₂ are aligned with one another with the animal toy 10 positioned along the floor surface in a horizontal orientation and with the first body portion 12, the mid-body portion 14 and the second body portion 16 also being aligned with one another in a straight line.

The first body portion 12, the mid-body portion 14 and the second body portion 16 can be manufactured in any of a variety of ways. For example, each of the first body portion 12, the mid-body portion 14 and the second body portion 16 can be injection molded as a single individual element. Alternatively, the first body portion 12, the mid-body portion 14 and the second body portion 16 can each be molded in a two-step process. In a first molding step, a base portion, such as base portions 12a, 14a and 16a (first molded parts), can be initially molded, as indicated in FIGS. 8, 9 and 10. The base portion 12a, 14a and 16a basically define a lower half of the respective body portion along with corresponding swivel connection end and socket connection end (whichever is required for that body portion) without an upper shape. Thereafter, in a second molding step respective final upper body shapes 12b, 14b and 16b (second molded parts) of each of the first body portion 12, the mid-body portion 14 and the second body portion 16 are molded over the corresponding base portions 12a, 14a and 16a, forming the final overall look and appearance of each of the first body portion 12, the mid-body portion 14 and the second body portion 16. The final upper body shapes 12b, 14b and 16b can further optionally provided with color, depending upon the overall design of the animal toy 10.

It should be understood from the drawings and the description herein that location of socket connection ends and swivel connection ends can be reversed. For example, the second body portion 16 can be provided with a socket connection end and the first body portion 12 can be provided with a swivel connection end. Further, the mid-body portion 14 can be reconfigured such that the swivel connection end can be formed at a front end of the mid-body portion 14 and the socket connection end can be formed at a rear end of the mid-body portion 14.

In the first embodiment, there is only a single mid-body portion 14. However, since the animal toy 10 is assembled from a plurality of body portions that snap-fit together, and the first and second swivel joints SJ_{T} and SJ_{H} are geometrically and dimensionally the same, a plurality of mid-body portions 14 can be added, making the animal toy 10 longer. In other words, since each of a plurality of the mid-body portions 14 can be snap-fitted to one another, the animal 10 can be easily lengthened making a longer animal toy.

### Second Embodiment

Referring now to FIG. 12, an animal toy 110 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

The animal toy 110 of the second embodiment is an example of an animal toy that includes a first body portion 112, a plurality of identical mid-body portions 114 and a second body portion 116. The first body portion 112 is a tail portion of the animal toy 110 and includes the first socket connection end 20 as described above with respect to the first embodiment. Each of the identical mid-body portions 114 defines a body portion, and further includes the first swivel connection 22 and the second socket connection end 24, as described above with respect to the first embodiment. The second body portion 116 is a head portion of the animal toy 110 and includes the second swivel connection end 26 described above with respect to the first embodiment.

The plurality of mid-body portions 114 snap-fit together such that adjacent pairs of the mid-body portions 114 define swivel joints SJ_{M}. The relative movements between the various mid-body portions 114 provided by the swivel joints SJ_{M} is basically the same as that provided by the first swivel joint SJ_{T} and the second swivel joint Ski as described above with respect to the first embodiment. Since the swivel joint connections such as the first swivel joint SJ_{T} and the second swivel joint SJ_{H} are fully described above with respect to the first embodiment, further description is omitted for the sake of brevity.

The first body portion 112 and each of the mid-body portions 114 includes a bottom surface with projections R formed thereon. In the second embodiment, the projections R are defined by elongated ridges that extend parallel to one another. As the animal toy 110 is pulled along a floor surface, the projections R can promote the rotating, pivoting and swiveling movements between the various body portions of the animal toy 110.

### Third Embodiment

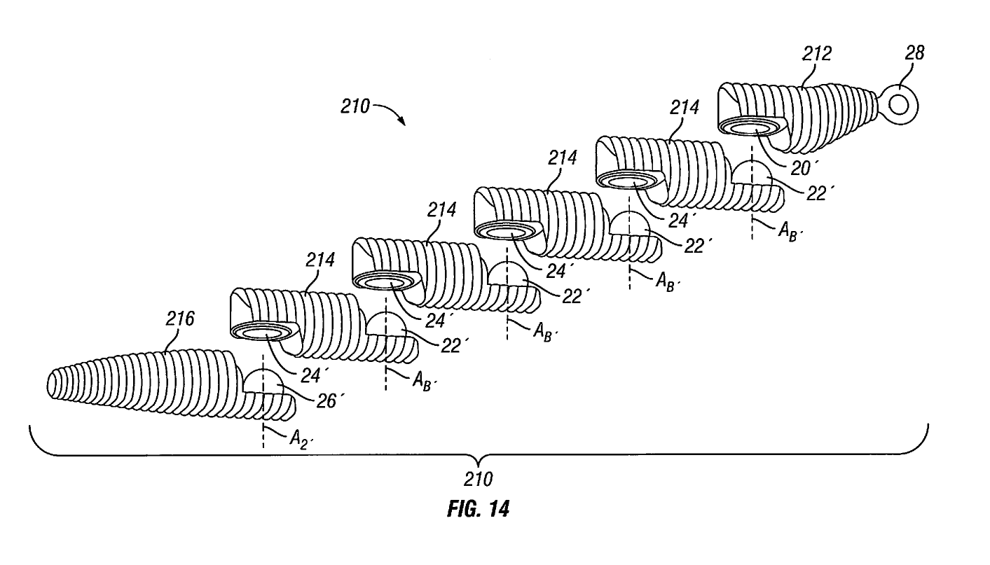

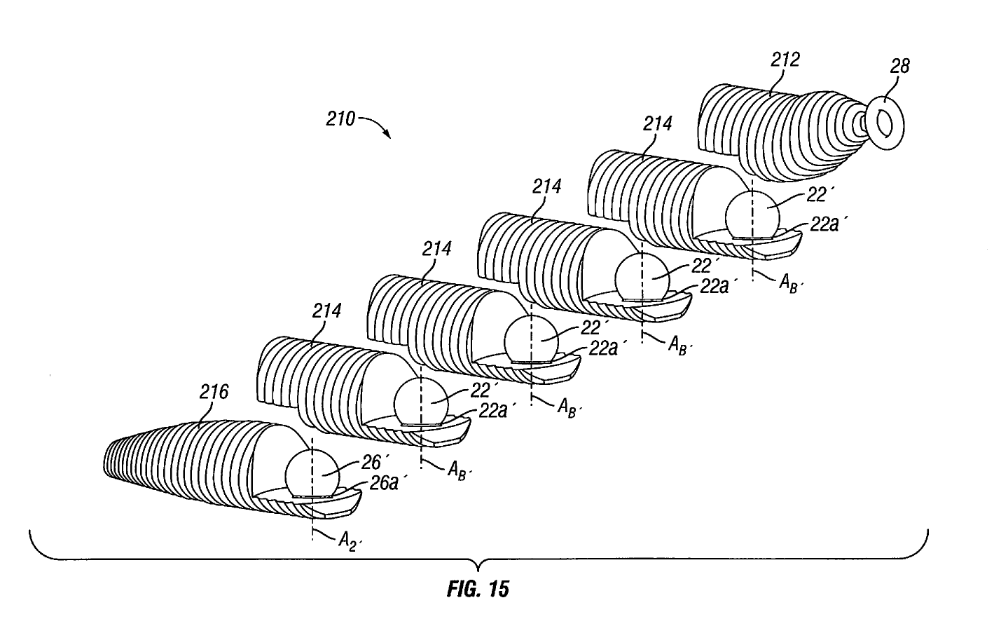

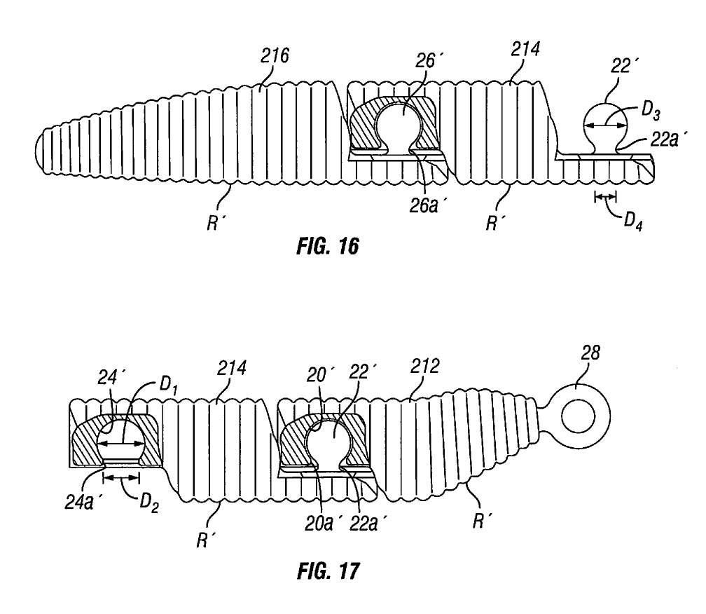

Referring now to FIGS. 13-17, an animal toy 210 in accordance with a third embodiment will now be explained. In view of the similarity between the first and third embodiments, the parts of the third embodiment that are identical to the parts of the first embodiment will be given the same reference numerals as the parts of the first embodiment. Moreover, the descriptions of the parts of the third embodiment that are identical to the parts of the first embodiment may be omitted for the sake of brevity. The parts of the third embodiment that differ from the parts of the first embodiment will be indicated with a single prime (′).

The animal toy 210 of the third embodiment is an example of an animal toy that includes a first body portion 212, a plurality of identical mid-body portions 214 and a second body portion 216. The first body portion 212 is a head portion of the animal toy 210 and includes a first socket connection end 20′ that has basically the same dimensions and function as the first socket connection end 20 of the first embodiment, except that the first socket connection end 20′ is vertically oriented relative to the first body portion 212, instead of being horizontally oriented as in the first embodiment. Specifically, the first socket connection end 20′ has the diameter D₁ and an opening 20a′ has the diameter D₂. The diameter D₁ and the diameter D₂ are dimensioned in a manner identical to that described above with respect to the first embodiment, except that the first socket connection end 20′ is vertically oriented relative to the first body portion 212. Further, the first body portion 212 of the third embodiment includes the hook or loop 28.

Each of the identical mid-body portions 214 defines a body portion, and further includes a first swivel connection 22′ and a second socket connection end 24′. The first swivel connection 22′ is basically the same dimensions and function as the first swivel connection end 22 of the first embodiment, except that a first axis A₁′ of the first swivel connection end 22′ is vertically oriented relative to the first body portion 212, instead of being horizontally oriented as in the first embodiment.

Specifically, the first swivel connection 22′ has spherical shape with the diameter D₃ and a neck portion 22a′ with the diameter D₄. The diameter D₃ and the diameter D₄ are dimensioned in a manner identical to that described above with respect to the first embodiment, except that the first swivel connection end 22′ is vertically oriented relative to the mid-body portion 214. Similarly, the second socket connection end 24′ has basically the same dimensions and function as the second socket connection end 24 of the first embodiment, except that the second socket connection end 24′ is vertically oriented relative to the mid-body portion 214, instead of being horizontally oriented as in the first embodiment. Specifically, the second socket connection end 24′ the diameter D₁ and an opening 24a′ having the diameter D₂. The diameter D₁ and the diameter D₂ are dimensioned in a manner identical to that described above with respect to the first embodiment, except that the second socket connection end 24′ is vertically oriented relative to the mid-body portion 212.

The second body portion 216 is a tail portion of the animal toy 210 and includes a second swivel connection end 26′. The second swivel connection end 26′ is basically the same dimensions and function as the second swivel connection end 26 of the first embodiment, except that a second axis A₂′ of the second swivel connection end 26′ is vertically oriented relative to the first body portion 212, instead of being horizontally oriented as in the first embodiment.

The plurality of mid-body portions 214 snap-fit together such that adjacent pairs of the mid-body portions 214 define swivel joints SJ_{M}′. The relative movements between the various mid-body portions 214 provided by the swivel joints SJ_{M}′ is basically the same as that provided by a first swivel joint SJ_{T} and a second swivel joint SJ_{H} similar to those described above with respect to the first embodiment. Since the swivel joint connections such as the first swivel joint SJ_{T} and the second swivel joint SJ_{H} are fully described above with respect to the first embodiment, further description is omitted for the sake of brevity.

The first body portion 212, each of the mid-body portions 214 and the second body portion 216 includes a bottom surface with projections R′ formed thereon. In the third embodiment, the projections R′ are defined by elongated ridges that extend parallel to one another. As the animal toy 210 is pulled along a floor surface, the projections R′ can promote the rotating, pivoting and swiveling movements between the various body portions of the animal toy 210.

In the third embodiment, the first axis A₁′, mid-body axes A_{B}′ and the second axis A₂′ are vertically oriented with the animal toy 210 positioned along the floor surface in a horizontal orientation. Further, the first axis A₁′, mid-body axes A_{B}′ and the second axis A₂′ are parallel to one another with the animal toy 210 positioned along a floor surface in a horizontal orientation and with the first body portion 212, the mid-body portions 214 and the second body portion 216 all being aligned with one another in a straight line.

The first body portion 212, the mid-body portions 214 and the second body portion 216 all include projections R′ that are in the form of circular ribs that completely encircle each body portions.

### Fourth Embodiment

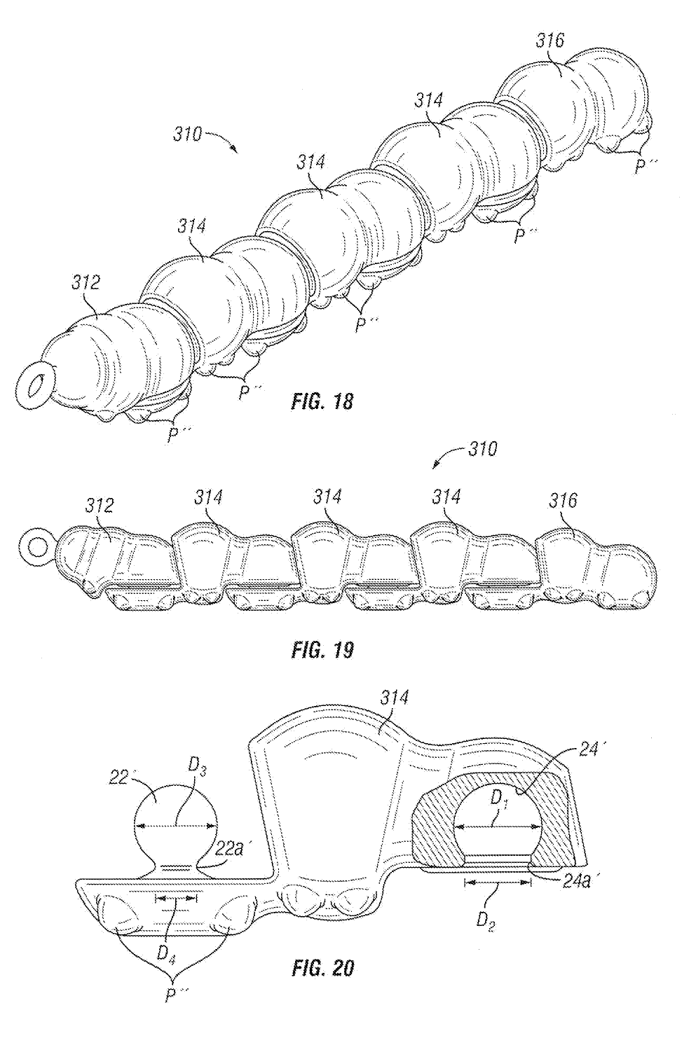

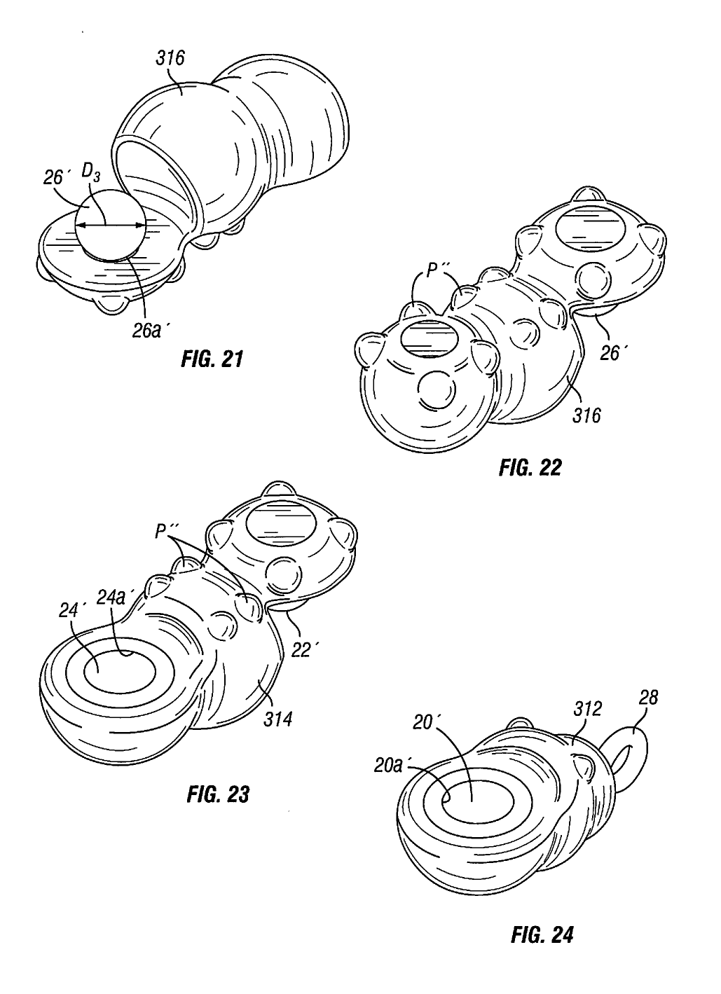

Referring now to FIGS. 18-24, an animal toy 312 in accordance with a fourth embodiment will now be explained. In view of the similarity between the first and fourth embodiments, the parts of the fourth embodiment that are identical to the parts of the first embodiment will be given the same reference numerals as the parts of the first embodiment. Moreover, the descriptions of the parts of the fourth embodiment that are identical to the parts of the first embodiment may be omitted for the sake of brevity. The parts of the fourth embodiment that differ from the parts of the first embodiment will be indicated with a single prime (′).

The animal toy 310 of the fourth embodiment is an example of an animal toy that includes a first body portion 312, a plurality of identical mid-body portions 314 and a second body portion 316. The first body portion 312 is a head portion of the animal toy 310 and includes the first socket connection end 20′ as described above with respect to the third embodiment. Specifically, the first socket connection end 20′ is vertically oriented relative to the first body portion 312, instead of being horizontally oriented as in the first embodiment. The first socket connection end 20′ has the diameter D₁ and an opening 20a′ has the diameter D₂. The diameter D₁ and the diameter D₂ are dimensioned in a manner identical to that described above with respect to the first embodiment, except that the first socket connection end 20′ is vertically oriented relative to the first body portion 312. Further, the first body portion 312 of the fourth embodiment includes the hook or loop 28.

Each of the identical mid-body portions 314 defines a body portion, and further includes the first swivel connection 22′ and the second socket connection end 24′. The first swivel connection 22′ is basically the same dimensions and function as described above with respect to the third embodiment. Specifically, the first axis A₁′ of the first swivel connection end 22′ is vertically oriented relative to the first body portion 312, instead of being horizontally oriented as in the first embodiment.

The first swivel connection 22′ has spherical shape with the diameter D₃ and a neck portion 22a′ with the diameter D₄. The diameter D₃ and the diameter D₄ are dimensioned in a manner identical to that described above with respect to the first embodiment, except that the first swivel connection end 22′ is vertically oriented relative to the mid-body portion 314. Similarly, the second socket connection end 24′ has basically the same dimensions and function as the second socket connection end 24 of the first embodiment, except that the second socket connection end 24′ is vertically oriented relative to the mid-body portion 314, instead of being horizontally oriented as in the first embodiment. Specifically, the second socket connection end 24′ the diameter D₁ and an opening 24a′ having the diameter D₂. The diameter D₁ and the diameter D₂ are dimensioned in a manner identical to that described above with respect to the first embodiment, except that the second socket connection end 24′ is vertically oriented relative to the mid-body portion 312.

The second body portion 316 is a tail portion of the animal toy 310 and includes the second swivel connection end 26′. The second swivel connection end 26′ is basically the same dimensions and function as described above with respect to the third embodiment. Specifically, the second axis A₂′ of the second swivel connection end 26′ is vertically oriented relative to the first body portion 312, instead of being horizontally oriented as in the first embodiment.

The plurality of mid-body portions 314 snap-fit together such that adjacent pairs of the mid-body portions 314 define swivel joints SJ_{M}′. The relative movements between the various mid-body portions 314 provided by the swivel joints SJ_{M}′ is basically the same as that provided by a first swivel joint SJ_{T} and a second swivel joint SJ_{H} similar to those described above with respect to the first embodiment. Since the swivel joint connections such as the first swivel joint SJ_{T} and the second swivel joint SJ_{H} are fully described above with respect to the first embodiment, further description is omitted for the sake of brevity.

The first body portion 312, each of the mid-body portions 314 and the second body portion 316 includes a bottom surface with projections R″ formed thereon. In the fourth embodiment, the projections R″ are conical protrusions.

As the animal toy 310 is pulled along a floor surface, the projections R′ can promote the rotating, pivoting and swiveling movements between the various body portions of the animal toy 310.

### Fifth Embodiment

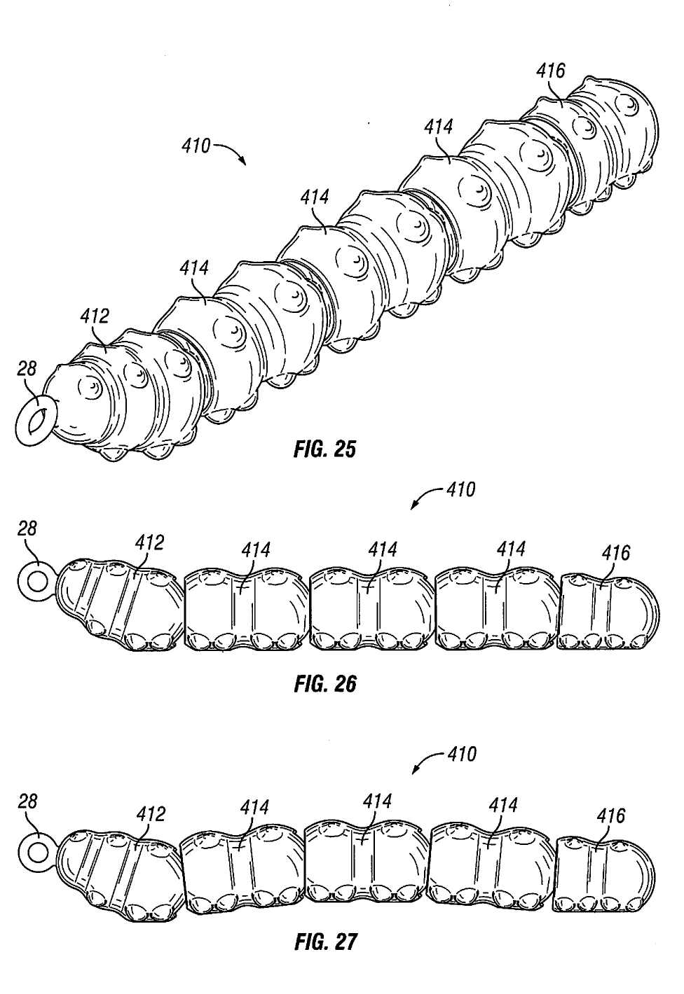

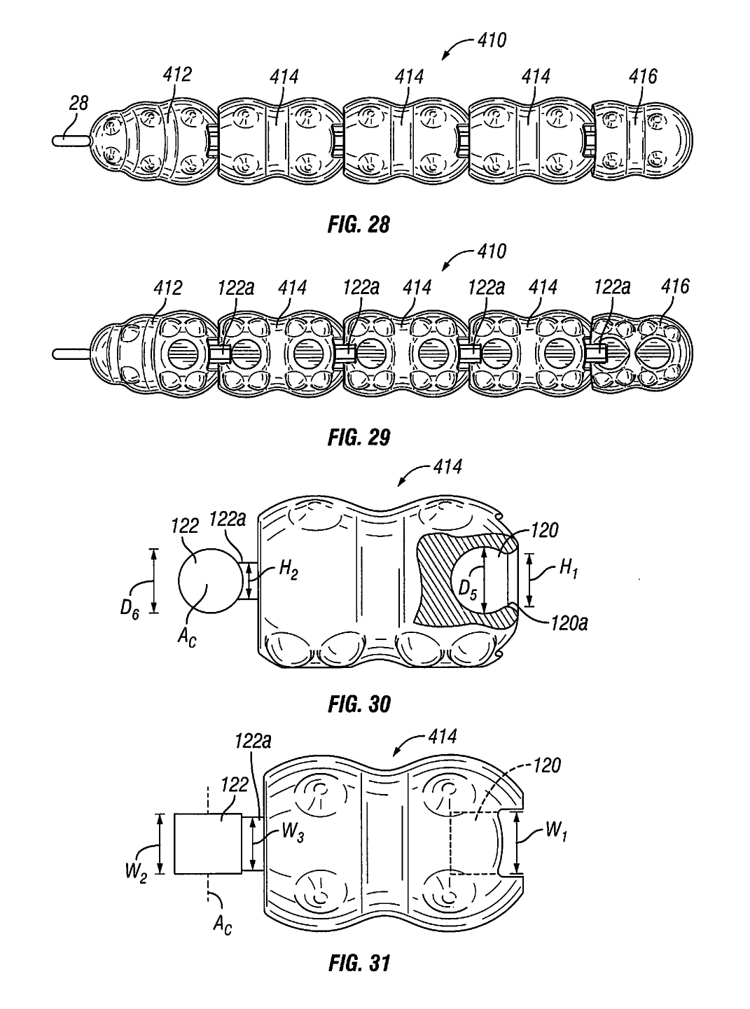

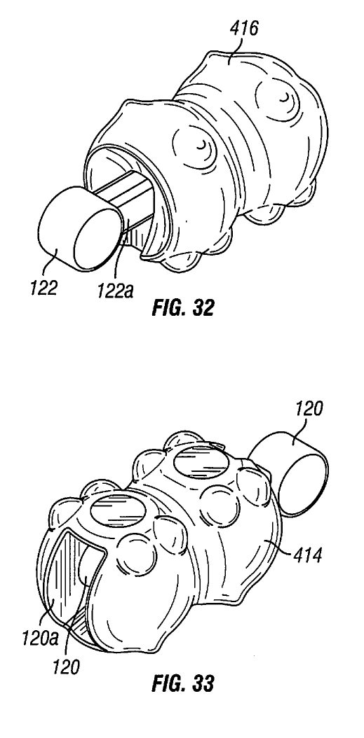

Referring now to FIGS. 25-33, an animal toy 410 in accordance with a fifth embodiment will now be explained. In view of the similarity between the first and fifth embodiments, the parts of the fifth embodiment that are identical to the parts of the first embodiment will be given the same reference numerals as the parts of the first embodiment. Moreover, the descriptions of the parts of the fifth embodiment that are identical to the parts of the first embodiment may be omitted for the sake of brevity.

The animal toy 410 of the fifth embodiment is an animal toy that includes a first body portion 412, a plurality of identical mid-body portions 414 and a second body portion 416. The first body portion 412 is a head portion of the animal toy 410 and includes a socket connection end 120. The plurality of mid-body portions 414 each include a swivel connection end 122 and another socket connection end 120. The second body portion 416 is a tail portion of the animal toy 410 and includes another swivel connection end 122.

In the fifth embodiment, the socket connection ends 120 and the swivel connection ends 122 of the animal toy 410 are not spherical in shape, but instead have cylindrical shapes. Specifically, each of the socket connection ends 120 basically defines a socket space having an inner curved surface that defines a diameter D₅ and a width W₁ as shown in FIGS. 30 and 31. Further, each socket connection end 120 has an opening 120a with a height H₁ and the width W₁. Each of the swivel connection end 122 has a cylindrical shape and a neck portion 122a. Each of the swivel connection ends 122 has a diameter D₆ and a width W₂. Further, the neck portion 122a has a height H₂ and a width W₃ as shown in FIGS. 30 and 31. Further, each of the swivel connection ends 122 defines a pivot axis A_{C}.

The height H₁ of the opening 120a of the socket connection end 120 is slightly smaller than the diameter D₆ of the swivel connection end 122. Therefore, the swivel connection end 122 must be snap-fitted into the socket connection end 120. However, the diameter D₅ of the socket connection end 120 is larger than the diameter D₆ of the swivel connection end 122. Therefore, the swivel connection end 122 can freely pivot about the axis A_{C} within the socket connection end 120. Further, the width W₁ of the socket connection end 120 is larger than the width W₂ of the swivel connection end 122. Therefore, the swivel connection end 122 can move slightly side to side within the socket connection end 120. As well, the height H₂ of the neck portion 122a is smaller than the height H₁ of the opening 120a, and the width H₃ of the neck portion 122a is smaller than the width W₁ of the socket space 120a and the opening 120a. Therefore, the neck portion 122a has freedom to move relative to the opening 120a.

The first body portion 412, each of the mid-body portions 414 and the second body portion 416 includes a bottom surface with projections R″ formed thereon. In the fifth embodiment, the projections R″ are conical protrusions. Further, upper surfaces of the first body portion 412, each of the mid-body portions 414 and the second body portion 416 can also include conical protrusions that resemble horns.

As the animal toy 410 is pulled along a floor surface, the projections R″ can promote the pivoting and swiveling movements between the various body portions of the animal toy 410.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “forward”, “rearward”, “above”, “downward”, “vertical”, “horizontal”, “below” and “transverse” as well as any other similar directional terms refer to those directions of a vehicle equipped with the animal toy. Accordingly, these terms, as utilized to describe the present invention should be interpreted relative to a vehicle equipped with the animal toy.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. An animal toy comprising:
a first body portion having an outer surface that defines one of an animal tail and an animal head, and having a first socket connection end;
at least one mid-body portion having an outer surface that defines at least a portion of an animal body, a first swivel connection end and a second socket connection end; and
a second body portion having an outer surface that defines the other of the animal tail and the animal head, and having a second swivel connection end, wherein
the first swivel connection end is snap-fitted into the first socket connection end defining a first swivel joint, and the second swivel connection end is snap-fitted into the second socket connection end defining a second swivel joint, the first swivel joint is pivotal about a first axis and the second swivel joint being freely pivotal about a second axis such that the first body portion is pivotally connected to the at least one mid-body portion and at least one the mid-body portion is pivotally connected to the second body portion such that in response to the first body portion, the at least one mid-body portion and the second body portion being pulled along a floor surface, the first body portion, the at least one mid-body portion and the second body portion freely pivot relative to one another.

2. The animal toy according to claim 1, wherein
each of the first swivel connector end and the second swivel connector end includes a projection having a curved outer surface that defines a first diameter, and
each of the first socket connection end and the second socket connection end includes a socket space having an inner curved surface that defines a second diameter larger than the first diameter such that with the first and second swivel connector ends installed within respective ones of the first and second socket connection ends, the first and second swivel connector ends are free to pivot with respect to the second and first socket connector ends.

3. The animal toy according to claim 2, wherein
each of the first socket connection end and the second socket connection end defines a first aperture open to the inner curved surface, the first aperture defining a first width that is smaller than the first diameter such that the first and second swivel connector ends are forced through a respective one of the first apertures in order to snap-fit the first and second swivel connector ends into the corresponding one of the first and second socket connector ends.

4. The animal toy according to claim 2, wherein
the socket space of each of the first socket connection end and the second socket connection end has an overall cylindrical shape.

5. The animal toy according to claim 2, wherein
the socket space of each of the first socket connection end and the second socket connection end has an overall spherical shape.

6. The animal toy according to claim 1, wherein
the first axis and the second axis are horizontally oriented with the articulate animal toy positioned along the floor surface in a horizontal orientation.

7. The animal toy according to claim 1, wherein
the first axis and the second axis are vertically oriented with the articulate animal toy positioned along the floor surface in a horizontal orientation.

8. The animal toy according to claim 1, wherein
the first axis and the second axis are aligned with one another with the articulate animal toy positioned along the floor surface in a horizontal orientation and with the first body portion, the at least one mid-body portion and the second body portion also being aligned with one another in a straight line.

9. The animal toy according to claim 1, wherein
the first axis and the second axis are parallel to one another with the articulate animal toy positioned along the floor surface in a horizontal orientation and with the first body portion, the at least one mid-body portion and the second body portion also being aligned with one another in a straight line.

10. The animal toy according to claim 1, wherein
the at least one mid-body portion comprises a plurality of mid-body portion members, each mid-body portion member including a swivel connection end and a socket connection end such that adjacent pairs of the mid-body portion members are connectable to one another, the swivel connection end of one of the adjacent pairs of the mid-body portion members being snap-fitted to the socket connection end of another of the adjacent pairs of the mid-body portion members.

11. The animal toy according to claim 1, wherein
the at least one mid-body portion comprises a first molded part that includes the first swivel connection end and the second socket connection end, and
a second molded part molded to a portion of the first molded part, the second molded part having the outer surface that defines at least the portion of the animal body.

12. The animal toy according to claim 1, wherein
the at least one mid-body portion defines a lower body portion and includes a plurality of projections shaped and configured for contact with the floor surface.

13. The animal toy according to claim 12, wherein
the plurality of projections are conical protrusions.

14. The animal toy according to claim 12, wherein
the plurality of projections are elongated ridges that extend parallel to one another.
